(19) United States
(12) Patent Application Publication
(10) Pub. No.: US 2025/0345912 A1
(43) Pub. Date: Nov. 13, 2025

(54) Attachments for a Hand-Held Rotary Power Tool

(71) Applicant: Robert Bosch GmbH, Stuttgart (DE)

(72) Inventors: Audel Gutierrez, Aurora, IL (US); Ralph Kramarski, Inverness, IL (US); Brian Haman, Chicago, IL (US); Tyler Jacknick, Antioch, IL (US); Saurabh Nanavati, Westmont, IL (US); Balazs Nagy, Roselle, IL (US); Joseph Scadutto, Hawthorn Woods, IL (US)

(21) Appl. No.: 19/203,234

(22) Filed: May 9, 2025

Related U.S. Application Data
(60) Provisional application No. 63/646,122, filed on May 13, 2024.

(51) Int. Cl. B25F 3/00; B23B 45/00; B23D 59/00; B23Q 17/24; B25F 5/00; B25F 5/02; B27C 5/10

(52) U.S. Cl. CPC B25F 3/00; B23B 45/003; B25F 5/001; B25F 5/02; B23D 59/003; B23Q 17/2404; B27C 5/10

(57) ABSTRACT

A power tool assembly includes a hand-held rotary power tool and a attachment. The power tool includes a power supply, a tool housing and motor that is disposed in the tool housing. The motor includes a motor output shaft that is configured to be mechanically connected to an accessory, which may also be part of the assembly. The power tool includes a controller disposed in the tool housing. The controller is configured to control a speed of the motor. The attachment is configured to be connected to the tool housing. In addition, the attachment is configured to be at least one of electrically connected to the controller, electrically connected to the power supply and mechanically connected to the motor output shaft.

### BACKGROUND

There are many types of specialized, hand-held rotary power tools. Such tools may include a tool housing that is shaped and sized to be easily held and manipulated by a user, and a motor that is disposed in the tool housing. An output shaft of the motor is used to drive a variety of rotating accessories including cutting blades, sanding heads, polishing heads, etcetera, that are detachably connected to the motor output shaft. Such accessories are used to modify a workpiece. Hand-held rotary power tools may also employ “attachments,” which are structures that attach to the power tool and enhance the function of the power tool. Unlike the accessories, the attachments do not modify the workpiece. Although attachments such as nose caps, plunge attachments, cutting guides, etcetera, enhance the ability of a user to operate the power tool, it is desirable to provide increased functionality to the attachments to enhance tool speed control, workpiece illumination, tool stability and other properties that affect tool use.

### SUMMARY

In some aspects, hand-held rotary power tool may be mechanically connected to an accessory in order to perform work on a workpiece. In addition, the power tool may be electrically and/or mechanically connected to an attachment that increases and/or improves the functionality of the power tool. Increased functionality of both the power tool and the attachment is achieved by providing an electrical and/or mechanical connection between the attachment and the power tool.

In some embodiments, a wired or wireless connection is provided between a switch or sensor on the attachment and a controller of the power tool, permitting control of the speed of the power tool at the attachment. The attachments having wired or wireless connection with the controller as described herein can be compared to some power tools and attachments in which no speed control is provided or speed control is only provided on the tool housing, which may be an inconvenient location in some applications.

In some embodiments, the power tool supplies power to the functional attachment, permitting the attachment to provide enhancements such as, but not limited to, illumination, tool stability, and monitoring and display of tool operating status. In other embodiments, supply of power to the functional attachment by the power tool permits fluids such as water or air to be applied to the workpiece-modifying accessories and/or the workpiece itself. These fluids may be used to provide cooling and/or to improve visibility during tool operation.

In some embodiments, the power tool is mechanically connected to the functional attachment such as a fluid pump or stabilizing gyroscope (i.e., a flywheel) in such a way that an actuator of the power tool drives the functional attachment.

The above-described interconnections between the attachment and the power tool may be employed alone or in combination with the other interconnections. For example, in some embodiments, a wired or wireless connection is provided between a switch or sensor on the attachment and a controller of the power tool, the power tool supplies power to the functional attachment and/or the power tool is mechanically connected to the functional attachment.

In some aspects, a hand-held rotary power tool assembly includes a hand-held rotary power tool and an attachment. The hand-held rotary power tool includes a power supply, a tool housing and a motor disposed in the tool housing. The motor has a motor output shaft that is configured to be mechanically connected to an accessory. The power tool includes a controller disposed in the tool housing. The controller is configured to control a speed of the motor. In addition, the power tool includes an attachment that is configured to be connected to the tool housing, the attachment configured to be at least one of electrically connected to the controller, electrically connected to the power supply and mechanically connected to the motor output shaft.

In some embodiments, the hand-held rotary power tool assembly includes the accessory.

In some embodiments, the attachment is a flex shaft attachment. The flex shaft attachment includes a shaft body having a first end that is detachably connected to the tool housing and a second end opposed to the first end. The second end has a handpiece configured to be held in a hand of a user. The flex shaft attachment also includes an internal rotation transmission wire having a proximal end that is connected to the spindle and a distal end supported on the handpiece. The rotation transmission wire transmits a rotational output of the motor output shaft to the rotation transmission wire distal end. The rotation transmission wire distal end is configured to be connected to an accessory. The handpiece includes a speed selection device. The speed selection device is electrically connected to the controller and the controller controls a speed of the motor based on an output signal from the speed selection device.

The output signal includes a first output signal or a second output signal. The speed selection device is a button switch configured so that when the button switch is not actuated, the first output signal is sent to the controller. In addition, based on the first output signal the controller maintains a current speed of the motor. When the button switch is actuated, the second output signal is sent to the controller and the controller increases a speed of the motor by a predetermined amount.

In some embodiments, the speed selection device is a rotary switch. The output signal corresponds to an angular position of the rotary switch and the controller adjusts a speed of the motor based on the output signal.

In some embodiments, the handpiece has an on-off switch that is electrically connected to the controller and is configured to control the supply of power to the motor.

In some embodiments, the handpiece includes a speed selection device. The speed selection device is configured to wirelessly communicate with the controller and the controller controls a speed of the motor based on a wireless signal received from the speed selection device.

In some embodiments, the wireless signal comprises a first wireless signal or a second wireless signal. The speed selection device is a button switch configured so that when the button switch is not actuated, the first wireless signal is sent to the controller and based on the first wireless signal the controller maintains a current speed of the motor. When the button switch is actuated, the second wireless signal is sent to the controller and the controller increases a speed of the motor by a predetermined amount.

In some embodiments, the speed selection device is a rotary switch, the wireless signal corresponds to an angular position of the rotary switch, and the controller adjusts a speed of the motor based on the wireless signal.

In some embodiments, the handpiece comprises an on-off switch that is wirelessly connected to the controller and is configured to control the supply of power to the motor.

In some embodiments, the attachment is a cutting guide that is detachably connected to the tool housing. The cutting guide is electrically connected to the tool housing in such a way that power from the power supply is supplied to a light source that is supported on the cutting guide.

In some embodiments, the light source includes LEDs arranged to direct illumination onto a workpiece.

In some embodiments, the cutting guide includes a guide housing that defines a window opening configured to permit a view of the workpiece through the guide housing, and the window opening is filled with a magnifying material.

In some embodiments, the attachment is a plunge router attachment that includes a base, a first rail and a second rail that are fixed to and extend from the base. In addition, the plunge router attachment includes a plunge housing that is supported above the base by the first rail and the second rail. The plunge housing supports the power tool in a spaced apart relationship with respect to the base. The plunge housing includes a first rail mount portion that is connected to the first rail, a second rail mount portion that is connected to the second rail and a tool mount portion that is disposed between and joins the first rail mount portion to the second rail mount portion. The tool mount portion is configured to receive and support the power tool housing. The tool mount portion includes a collar portion configured to surround and support the power tool. The first rail mount portion has a first hand grip that protrudes from an outer surface of the first rail mount portion and the second rail mount portion has a second hand grip that protrudes from an outer surface of the second rail mount portion. One of the first hand grip and the second hand grip includes a speed selection device. The speed selection device is electrically connected to the controller, and the controller controls a speed of the motor based on an output signal from the speed selection device.

In some embodiments, the other of the first hand grip and the second hand grip includes an on/off switch configured to control the on/off mode of the power tool.

In some embodiments, the output signal comprises a first output signal or a second output signal. The speed selection device is a button switch configured so that when the button switch is not actuated, the first output signal is sent to the controller and based on the first output signal the controller maintains a current speed of the motor. When the button switch is actuated, the second output signal is sent to the controller and the controller increases a speed of the motor by a predetermined amount.

In some embodiments, the speed selection device is a rotary switch, the output signal corresponds to an angular orientation of the rotary switch, and the controller adjusts a speed of the motor based on the output signal.

In some embodiments, the attachment is a nose cap that is detachably connected to the tool housing so as to surround the motor output shaft. The nose cap is electrically connected to the tool housing in such a way that power from the power supply is supplied to a light source that is supported on the nose cap.

In some embodiments, the light source includes LEDs arranged to direct illumination onto a workpiece.

In some embodiments, the light source includes a first set of LEDs which are configured to provide a first field of light and a second set of LEDs which are configured to provide a second field of light, and the first field of light has a greater intensity and a smaller area than the second field of light.

In some embodiments, the nose cap includes a sensor that is electrically connected to controller in such a way that the sensor receives power via the controller. The controller receives an output signal from the sensor and is configured to control the light source based on the output signal.

In some embodiments, the sensor is an accelerometer and the controller controls the light source to provide an indication of the orientation of the power tool in space based on the output signal received from the accelerometer.

In some embodiments, the sensor detects a current drawn by the motor and the controller controls the light source to provide an indication of the current drawn by the motor.

In some embodiments, the attachment is a nose cap that is detachably connected to the tool housing so as to surround the motor output shaft. The nose cap includes a speed selection device. The speed selection device is electrically connected to the controller, and the controller controls a speed of the motor based on an output signal from the speed selection device.

In some embodiments, the output signal comprises a first output signal or a second output signal. In addition, the speed selection device is a button switch configured so that when the button switch is not actuated, the first output signal is sent to the controller and based on the first output signal the controller maintains a current speed of the motor. When the button switch is actuated, the second output signal is sent to the controller and the controller increases a speed of the motor by a predetermined amount.

In some embodiments, the speed selection device is a rotary switch. The output signal corresponds to an angular position of the rotary switch and the controller adjusts a speed of the motor based the output signal.

In some embodiments, the tool housing comprises a primary hand grip. In addition, the attachment is a detailer's grip attachment. The detailer's grip attachment includes an attachment mount configured to be detachably connected to the tool housing and a secondary hand grip. The secondary hand grip has a different shape and/or orientation than the primary hand grip. The secondary hand grip includes a speed selection device. The speed selection device is electrically connected to the controller and the controller controls a speed of the motor based on an output signal from the speed selection device.

In some embodiments, the output signal comprises a first output signal or a second output signal. The speed selection device is a button switch configured so that when the button switch is not actuated, the first output signal is sent to the controller and based on the first output signal the controller maintains a current speed of the motor. When the button switch is actuated, the second output signal is sent to the controller and the controller increases a speed of the motor by a predetermined amount.

In some embodiments, the speed selection device is a rotary switch, the output signal corresponds to an angular position of the rotary switch and the controller adjusts a speed of the motor based on the output signal.

In some embodiments, the secondary hand grip comprises an on-off switch that is electrically connected to the controller and is configured to control the supply of power to the controller.

In some embodiments, the detailer's grip attachment comprises a magnifying lens. The magnifying lens is connected to the detailer's grip attachment by a pivot pin, whereby the magnifying lens is pivotable relative to the detailer's grip attachment between a folded and stowed position and an extended position. In the folded and stowed position, the magnifying lens overlies a surface of the detailer's grip attachment. In the extended position, the magnifying lens is arranged side-by-side with the detailer's grip attachment.

In some embodiments, the detailer's grip attachment includes an internal vacancy, an opening that connects the internal vacancy with an environment of the detailer's grip attachment and a blower disposed in the internal vacancy. The blower has a fan motor that is electrically connected to the power supply and a fan that disposed in the opening. In some embodiments, the fan is driven by the fan motor. In other embodiments, the fan is mechanically connected to and driven by the motor output shaft.

In some embodiments, the attachment is a foot pedal attachment that is wirelessly connected to the controller. The foot pedal attachment includes a base, a pedal that is pivotably connected to the base, and a sensor configured to detect an angle of the pedal with respect to the base and wirelessly provide an output signal to the controller. The output signal corresponds to the detected angle, and the controller controls a speed of the motor based on an output signal from the foot pedal attachment.

In some embodiments, the attachment is a saw attachment. The saw attachment includes an attachment housing configured to be detachably connected to the tool housing and encircle a portion of a circumference of the tool housing. The saw attachment also includes a cutting accessory connector and a gear set disposed in the attachment housing. The gear set is configured to transmit the rotary output of the motor into a gearset rotary output appropriate for driving a cutting accessory that is connected to the cutting accessory connector. The gear set is connected to the cutting accessory connector and transmits the gearset rotary output to the cutting accessory connector. At least one of a light control switch and a speed control switch is disposed in the attachment housing. The at least one of the light control switch and the speed control switch is electrically connected to the controller. The controller controls a speed of the motor based on an output signal from the speed control switch and controls a light source based on an output signal from the light control switch.

In some embodiments, the cutting accessory connector is configured to connect a jigsaw blade to an output of the gearset. The saw attachment comprises a light source disposed on the attachment housing and configured to direct light toward a workpiece. In some embodiments, the at least one of the light control switch and the speed control switch is a light control switch. In some embodiments, the light source provides general illumination. In some embodiments, the light source is a laser light source disposed on the attachment housing and configured to direct a beam of laser light toward a workpiece.

In some embodiments, the cutting accessory connector is configured to connect a circular saw blade to an output of the gearset. The saw attachment comprises a light source disposed on the attachment housing and configured to direct light toward a workpiece. In some embodiments, the at least one of the light control switch and the speed control switch is a light control switch. In some embodiments, the light source provides general illumination. In some embodiments, the light source is a laser light source disposed on the attachment housing and configured to direct a beam of laser light toward a workpiece.

In some embodiments, the cutting accessory connector is configured to connect a pipe cutting saw blade to an output of the gearset. The saw attachment comprises a set of rollers is pivotably mounted in the attachment housing so as to protrude from an outer surface of the attachment housing. The rollers have a rotational axis that is parallel to a rotational axis of the motor output shaft. In addition, the rollers are spaced apart about a circumference of the outer surface.

In some embodiments, the attachment is a press assembly configured to rest on a support surface. The press assembly includes a base that rests on the support surface, a rail that extends from the base and a press housing that supports the power tool in a spaced relationship relative to the base. The press housing includes a rail mount portion that is connected to the rail, a tool mount portion that is configured to receive and support the power tool housing, a gear set that movably connects the tool mount portion to the rail mount portion and a lever that is mechanically connected to the gearset. Operation of the lever adjusts a position of the tool mount portion relative to the base between a first position in which the tool mount portion is a first distance from the base and a second position in which the tool mount portion is a second distance from the base. The lever comprises a speed selection device. The speed selection device is electrically connected to the controller, and the controller controls a speed of the motor based on an output signal from the speed selection device.

In some embodiments, the output signal comprises a first output signal or a second output signal. The speed selection device is a button switch configured so that when the button switch is not actuated, the first output signal is sent to the controller and based on the first output signal the controller maintains a current speed of the motor. When the button switch is actuated, the second output signal is sent to the controller and the controller increases a speed of the motor by a predetermined amount.

In some embodiments, the speed selection device is a rotary switch. The output signal corresponds to an angular position of the rotary switch and the controller adjusts a speed of the motor based the output signal.

In some embodiments, the attachment is a water delivery attachment that includes an attachment housing having an attachment mount configured to be detachably connected to the tool housing. The water delivery attachment includes a reservoir disposed in the attachment housing and configured to contain a fluid and a fluid pump disposed in the attachment housing. The water delivery attachment includes a first fluid line that connects the reservoir to an inlet of the fluid pump, a second fluid line that is connected to an output of the fluid pump, the second fluid line configured to be directed at a workpiece, and a sensor supported on the attachment housing and configured to detect a temperature of the accessory. The sensor is also configured to output an output signal to the controller that represents a temperature of the accessory. The controller is configured to control the operation of the fluid pump based on the output signal of the sensor.

In some embodiments, the attachment is a tool stabilizer attachment. The tool stabilizer attachment includes a stabilizer housing that surrounds the output shaft and an attachment mount supported on the stabilizer housing. The attachment mount is configured to detachably connect the stabilizer housing to the tool housing. The tool stabilizer attachment includes a flywheel disposed in the stabilizer housing. The flywheel has a collar having an inner surface that surrounds the output shaft and a speed multiplier. The speed multiplier is disposed between the collar and the output shaft. An outer surface of the speed multiplier is connected to the collar inner surface and an inner surface of the speed multiplier is connected to the output shaft whereby the flywheel rotates at a speed that is greater than the rotational speed of the output shaft.

In some embodiments, the attachment is a drill driver attachment that is detachably connected to the power tool. The drill driver attachment includes a gearset that has a driver input shaft that is mechanically connected to the motor output shaft and a driver output shaft that rotates at a different speed than the motor output shaft. The driver output shaft is configured to be detachably connected to a bit. The drill driver attachment is configured to transmit a rotational output of the motor output shaft to the bit at a modified rotational speed.

### BRIEF DESCRIPTION OF THE DRAWINGS

FIG. 1 is a top perspective view of the hand-held rotary power tool including a nose cap attachment supported on the front end of the power tool and showing a cutting wheel accessory in exploded form.

FIG. 2 is a side view of the power tool of FIG. 1, shown with a portion of the tool housing removed to permit visualization of the internal components of the rotary power tool and with the nose cap attachment and cutting wheel accessory omitted.

FIG. 3 is a schematic illustration of an electrical circuit of the rotary power tool.

FIG. 4 is a perspective view of a nose cap attachment illustrating embedded electrical conductors in broken lines.

FIG. 5 is a perspective view of a portion of the rotary power tool illustrating a light source on the nose cap distal end.

FIG. 6 is a side view of a rotary power tool including a nose cap attachment designed to support a toe of a dog or cat.

FIG. 7 is an illustration of a toe nail of a dog being trimmed by the rotary power tool of FIG. 6.

FIG. 8 is a perspective view of the nose cap of FIG. 6 illustrating an annular light band used for illuminating the dog toe nail.

FIG. 9 is a side view of a rotary power tool with a nose cap attachment illustrating a first illumination mode of the nose cap.

FIG. 10 is a side view of the rotary power tool of FIG. 9, illustrating a second illumination mode of the nose cap.

FIG. 11 is a schematic illustration of a nose cap including an exemplary indicator light source used in combination with a current sensor.

FIG. 12 is a schematic illustration of a nose cap including another exemplary indicator light source used in combination with a current sensor.

FIG. 13 is a schematic illustration of a nose cap including yet another exemplary indicator light source used in combination with an accelerometer.

FIG. 14 is a schematic illustration of a nose cap including an exemplary speed control switch.

FIG. 15 is a schematic illustration of an alternative embodiment electrical circuit of the rotary power tool.

FIG. 16 is a schematic illustration of a nose cap including another exemplary speed control switch.

FIG. 17 is a schematic illustration of a nose cap that cooperates wirelessly with a foot pedal speed control switch.

FIG. 18 is a schematic illustration of a water delivery attachment supported on a nose cap.

FIG. 19 is an alternative version of the schematic of FIG. 18.

FIG. 20 is a schematic illustration of a rotary power tool including a drill driver attachment.

FIG. 21 is a schematic illustration of a tool press attachment in which a rotary power tool is illustrated in light broken lines and electrical conductors are represented in heavy broken lines.

FIG. 22 is an alternative version of the schematic of FIG. 21, in which broken lines represent electrical conductors.

FIG. 23 is a perspective view of a cutting guide attachment.

FIG. 24 is an illustration of a rotary power tool assembled with the cutting guide attachment of FIG. 23.

FIG. 25 is a schematic illustration of the cutting guide of FIG. 23 illustrating electrical conductors in broken lines.

FIG. 26 is a perspective view of a router plunge attachment.

FIG. 27 is a schematic illustration of an alternative embodiment hand grip.

FIG. 28 is a schematic illustration of the router plunge attachment of FIG. 26 illustrating the rotary power tool in light broken lines and electrical conductors in heavy broken lines.

FIG. 29 is a perspective view of a detailer's grip attachment illustrating the magnifying device in a folded and stowed configuration.

FIG. 30 is perspective view of a rotary power tool assembled with the detailer's grip attachment of FIG. 29 illustrating the magnifying device in a folded and stowed configuration.

FIG. 31 is a perspective view of the detailer's grip attachment of FIG. 29 illustrating the magnifying device in an unfolded configuration.

FIG. 32 is a perspective view of an alternative embodiment detailer's grip attachment illustrating the magnifying device in an unfolded configuration and including a blower.

FIGS. 33A is a perspective view of a flex shaft attachment.

FIG. 33B is a perspective view of a rotary power tool assembled with the flex shaft attachment of FIG. 33A.

FIG. 33C is a cross-sectional view of the flex shaft attachment as seen along line 33C-33C illustrating the rotation transmission wire is disposed coaxially within the flex shaft body.

FIG. 34 is a perspective view of the flex head of the flex shaft attachment of FIGS. 33A-C illustrating a light source and light control switches disposed on the flex head.

FIG. 35 is a side cross-sectional view of a stabilizer attachment assembled with a rotary power tool.

FIG. 36 is a schematic illustration of a pipe cutter attachment assembled with a rotary power tool.

FIG. 37 is an exploded side view of a jigsaw attachment assembled with a rotary tool.

FIG. 38 is a side view of a jigsaw attachment assembled with a rotary tool.

FIG. 39 is an exploded side view of a circular saw attachment assembled with a rotary tool.

FIG. 40 is a side view of a circular saw attachment assembled with a rotary tool.

### DETAILED DESCRIPTION

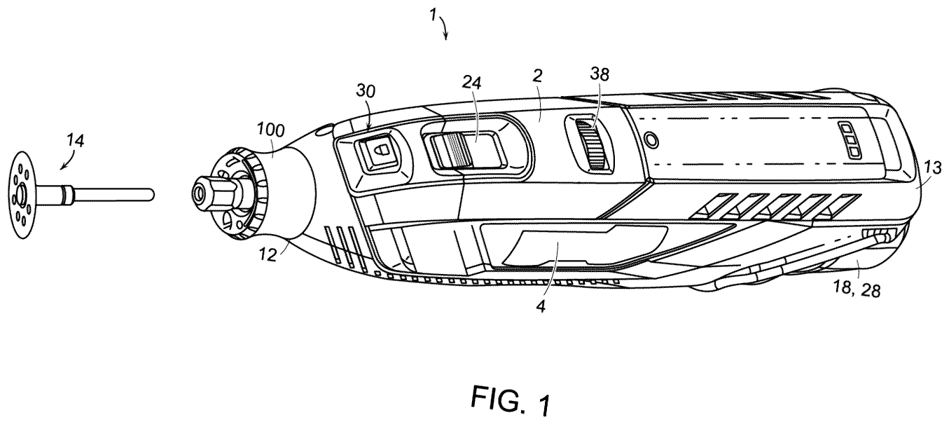

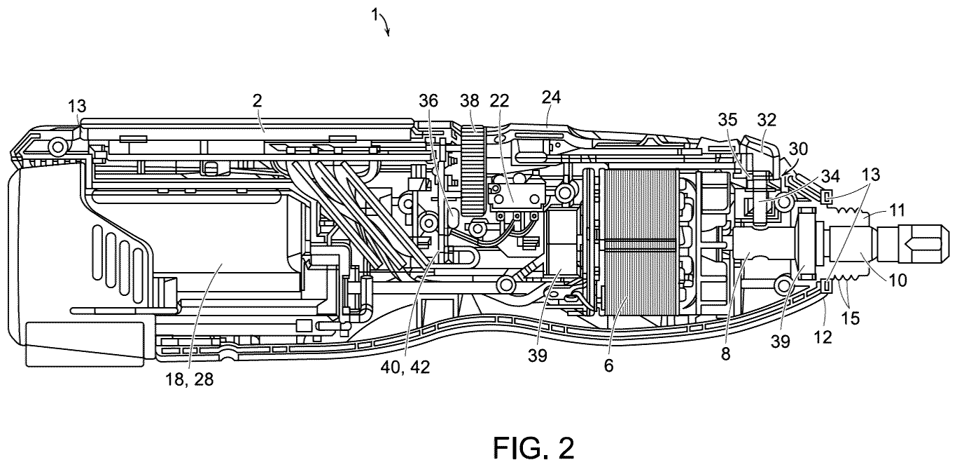

Referring to FIGS. 1 and 2, a hand-held rotary power tool 1 includes a tool housing 2. The tool housing 2 has a generally cylindrical shape that is ergonomically contoured to be grasped in the hand of a user, whereby a central portion 4 of the tool housing 2 serves as a handle or grip of the rotary power tool 1. The rotary power tool 1 includes an electric motor 6 disposed in the tool housing 2. The motor 6 may be a brushed or brushless DC motor and is controlled by a controller 36 via an electrical circuit 20 that includes an on/off electrical switch 22 and a power supply 18. An output shaft 8 of the electric motor 6 extends in parallel to an elongation direction of the tool housing 2 and is connected in a gearless fashion to a tool spindle 10. The tool spindle 10 protrudes outward from a first end 12 of the tool housing 2 and is configured to provide a mechanical connection to various workpiece modifying accessories 14 for the purpose of processing a workpiece. The accessories 14 may include, but are not limited to, engraving cutters, milling cutters, grinding disks, grindstones, polishing tips, polishing disks, polishing brushes, cutting disks, saw blades and bits. An exemplary accessory 14 in the form of a cutting disc is shown in FIG. 1.

The motor 6 is powered by the power supply 18 that is detachably connected to a second end 13 of the tool housing 2. The switch 22 is disposed in the electrical circuit 20 between the controller 36 and the power supply 18. The electrical switch 22 is entirely disposed within the tool housing 2 and is actuated by an operator of the rotary power tool 1 via a switch actuator 24. The switch actuator 24 is protrudes through an opening in the tool housing 2 so as to be accessible to an operator of the rotary power tool 1.

In the illustrated embodiment, the power supply 18 includes a rechargeable battery pack 28 that is detachably connected to the tool housing second end 13. In other embodiments, the power supply 18 may consist of primary batteries that are housed within the tool housing 2. In still other embodiments, the power supply 18 may be remote from the tool housing 2 and connected to the tool housing 2 via a cord (not shown) that encloses an electrically conductive wire.

When the electrical switch 22 is in the “on” position, the electric motor 6 drives the tool spindle 10 at a rotational speed higher than 10 000 min-1. In some embodiments, the rotational speed of the electric motor 6 can be adjusted by an operator between 5 000 min-1 and 40 000 min-1 via a rotary speed control knob 38.

In some embodiments, the rotary power tool 1 includes an output shaft lock mechanism 30 having a depressible control button 32 that caps a locking shaft 34. The locking shaft 34, when actuated by the control button 32, is configured to engage an opening in the output shaft 8 to prevent rotation of the output shaft 8 while an accessory 14 is being attached thereto. The output shaft lock mechanism 30 also includes a spring 35 that biases the locking shaft 30 and control button 32 toward a disengaged configuration.

The tool housing 2 encloses the motor 6, the electrical switch 22, the switch actuator 24, the output shaft lock mechanism 30, the speed control knob 38, output shaft support bearings 39, the controller 36 and other ancillary components and structures.

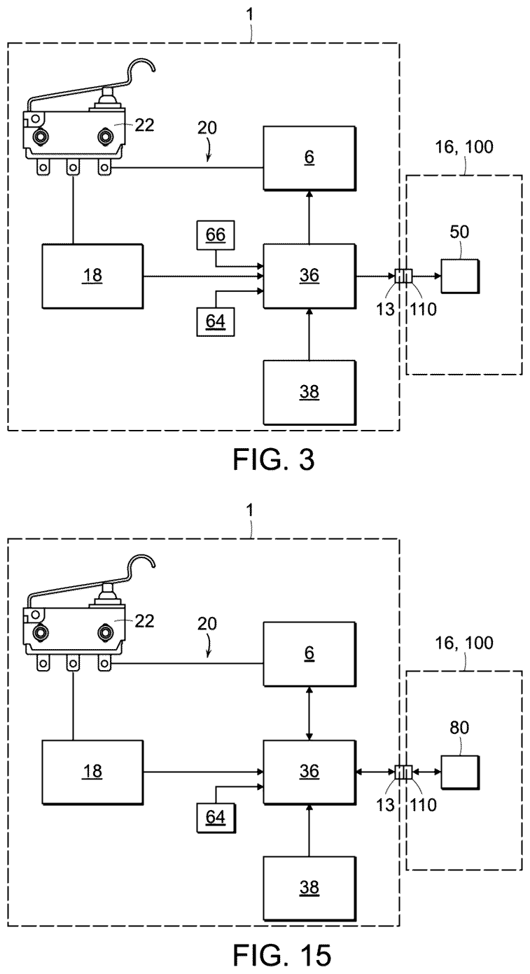

Referring to FIGS. 2 and 3, the controller 36 is part of a printed circuit board assembly (PCBA) 40 that includes other ancillary electronic devices (not shown) supported on a printed circuit board (PCB) 42. The electronics supported on the PCBA 40 including the controller 36 are powered by the power supply 18. The controller 36 may be communicatively coupled with various operational components of rotary power tool 1, including, but not limited to, the electrical switch 22, the rotary speed control knob 38, a battery management system (BMS), sensors or other input devices, etc. As used herein, the term “communicatively coupled” may refer to a direct wired connection via for example conductive signal lines, shared communication busses, or alternatively may refer to a wireless connection. As used herein, references to wireless connectivity or communication indicates that the device may be configured to communicate wirelessly via one or more of an RF (radio frequency) specification, cellular phone channels (analog or digital), cellular data channels, a Bluetooth specification, a Wi-Fi specification, a satellite transceiver specification, infrared transmission, a Zigbee specification, Local Area Network (LAN), Wireless Local Area Network (WLAN), or any other alternative configuration, protocol, or standard known to one of ordinary skill in the art.

Thus, controller 36 can receive information from these devices and selectively activate and operate the various operational components. The controller 36, for example, may control a voltage supplied to the electric motor 6.

In some embodiments, controller 36 includes one or more memory devices and one or more processors. The processors may be any combination of general or special purpose processors, CPUs, or the like that can execute programming instructions or control code associated with operation of the rotary power tool 1. The memory devices (i.e., memory) may represent random access memory such as DRAM or read only memory such as ROM or FLASH. In some embodiments, the processor executes programming instructions stored in memory. The memory may be a separate component from the processor or may be included onboard within the processor. Alternatively, the controller 36 may be constructed without using a processor, for example, using a combination of discrete analog or digital logic circuitry (such as switches, amplifiers, integrators, comparators, flip-flops, AND gates, and the like) to perform control functionality instead of relying upon software.

In some embodiments discussed below, the controller 36 includes a network interface such that the controller 36 can connect to and communicate over one or more networks (not shown). The controller 36 may also include one or more transmitting, receiving, or transceiving components for transmitting and/or receiving communications with other devices communicatively coupled with the rotary power tool 1. Additionally, or alternatively, the transmitting, receiving, or transceiving components can be located off board controller 36. Generally, the PCBA 40 including the controller 36 may be positioned in any suitable location throughout tool housing 2.

The various functions performed by the controller 36 may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The tool housing first end 12 includes an annular protrusion 11 that is centered on the rotational axis of the spindle 10. The protrusion 11 encircles the spindle 10 with sufficient clearance to permit rotation of the spindle 10 therein and has an outer thread 15 that permits attachments 16 to be connected to the rotary power tool 1. The spindle 10 extends through the protrusion 11 and a terminal end of the spindle 10 resides outside the protrusion 11. In addition, the tool housing 2 may include two or more electrical contacts 13 (only two electrical contacts are shown) disposed on the tool housing first end 12. In the illustrated embodiment, the electrical contacts 13 are disposed on the tool housing first end 12 so as to be spaced apart about the protrusion 11. The electrical contacts 13 are electrically connected to the electric circuit 20 and are used to provide electrical connections between components of the electric circuit 20 and the attachments 16 that are mechanically connected to the rotary power tool 1.

In some uses, the rotary power tool 1 may be assembled with the attachments 16, which are structures that can be mechanically connected to the rotary power tool 1 and enhance the functionality of the rotary power tool 1. Unlike the accessories 14, the attachments 16 do not modify the workpiece. Although some attachments 16 including, but not limited to, nose caps 100, router plunge attachments 150, cutting guides 130, and others (some described below) enhance the ability of a user to operate the rotary power tool 1, it is desirable to provide increased functionality to the attachments 16 to enhance tool speed control, workpiece illumination, tool stability and other properties that facilitate tool use and improve user experience.

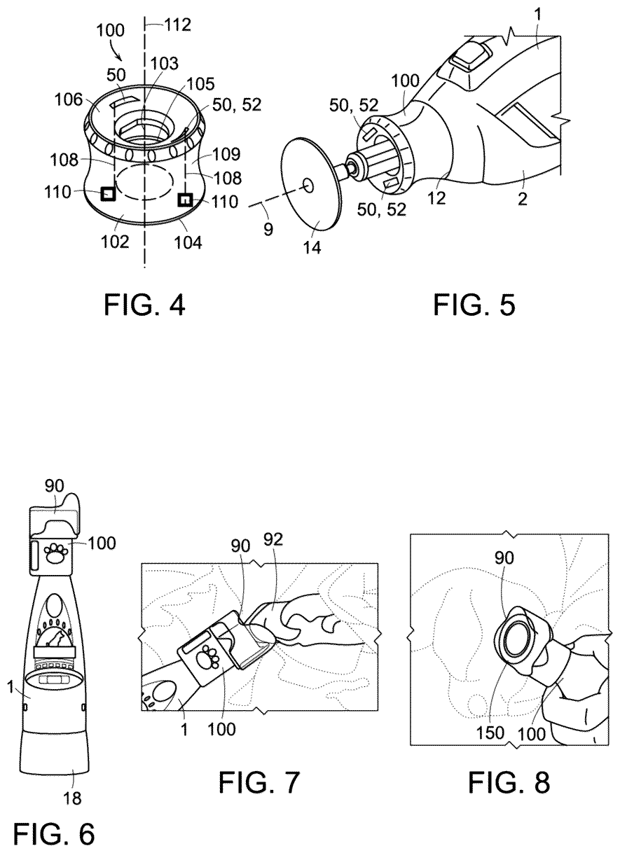

Referring to FIGS. 3-5, an exemplary attachment 16 is a nose cap 100. The nose cap 100 has a generally hollow, thick-walled, cylindrical nose housing 102. An inner surface 103 of the nose housing 102 includes a thread 105 that is configured to engage with the external thread 15 of the protrusion 11. An outer surface 109 of the nose housing 102 has a concavity that extends circumferentially and provides a secondary grip that permits the user to grasp the rotary power tool 1 in a “pencil grip.” A centerline 112 of the nose cap 100 is aligned with the axis of rotation 9 of the spindle 10 and motor output shaft 8.

The nose cap 100 includes a pair of embedded electrical conductors 108 that extend between a proximal end 104 and a distal end 106 of the nose cap 100. One end of the electrical conductors 108 are electrically connected to electrical contacts 110 provided on the nose cap proximal end 104. In the illustrated embodiment, the nose cap 100 includes two electrical conductors 108 and thus two electrical contacts 110 but is not limited to having only two electrical conductors. The nose cap 100 is removably attached to the housing first end 12 via threaded engagement between the protrusion outer thread 15 and the nose cap internal thread 105. When the nose cap 100 is attached to the tool housing first end 12, the nose cap electrical contacts 110 form an electrical connection with the electrical contacts 13 of the tool housing first end 12, whereby the nose cap 100 is electrically connected to the power supply 18 via the controller 36. In this configuration, a portion of the spindle 10 is surrounded by nose cap 100 and an end of the spindle 10 protrudes outward from the nose cap 24 to permit engagement between the spindle 10 and an accessory 14.

In the illustrated embodiment, power is supplied to a light source 50 provided in the nose cap 100 via the electrical conductors 108, which in turn are electrically connected to the power tool electrical circuit 20. The power supply 18 is activated by the switch actuator 24 mentioned above. When the power supply is activated, the light source 50 illuminates a work area in front of the rotary power tool.

In the nose cap 100, the electrical conductors 108 supply power to multiple individual light sources 50 that are contained in the nose cap 100 and arranged to illuminate the workpiece. In the illustrated embodiment, the nose cap 100 includes two light sources such as light emitting diodes (LEDs) 52 that emit light from the nose cap distal end 106. Other types of light sources 50 may be used in the place of LEDs.

Referring to FIGS. 6-8, as an alternative configuration to multiple discrete or point light sources, the light source 50 may be in the form of an annular light band 150. The light band 150 may be an annular transparent structure that is illuminated, and may be employed on a pet grooming attachment in which the nose cap 100 or similarly configured attachment provides a support surface 90 upon which a toe 92 of a pet such as a dog may rest, while the accessory 14 is used to trim the toe nail of the pet. The light band 150 is mounted so as to extend around a periphery of the support surface 90. By surrounding the toe nail with the light band 150, the toe nail is illuminated. Under such lighting conditions, the pet toe nail becomes partially transparent, allowing the tool user to clearly see the internal structures of the nail while trimming. Such illumination prevents over-trimming of the pet toe nail.

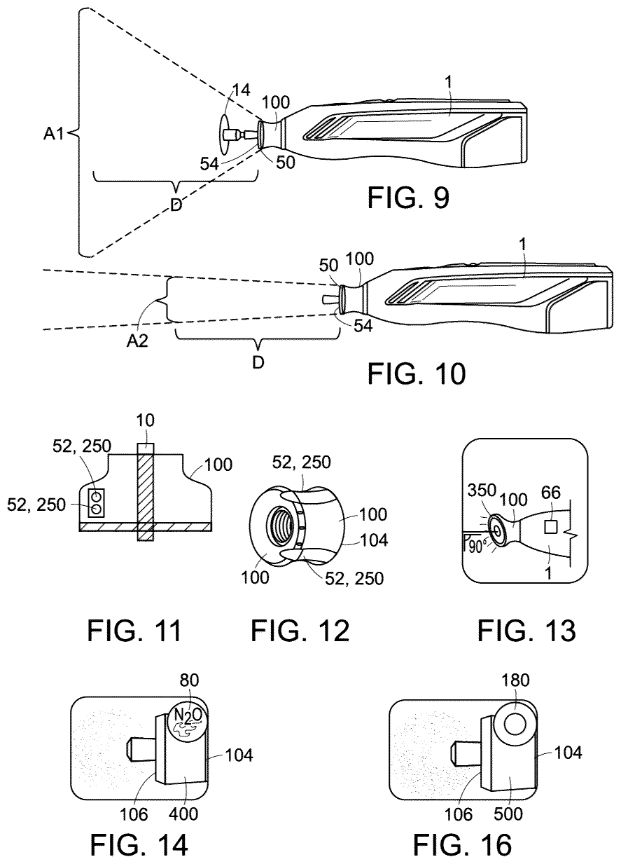

Referring to FIGS. 9 and 10, another alternative lighting configuration usable in an attachment 16 such as nose cap 100 advantageously permits a selection between two light modes. In the first mode, the light source 50 is configured to provide a conical field of light in which the angle of the conical field is wide and the illuminated area A1 is large at a predetermined distance D from the light source 50 (FIG. 9). In the first mode, the light in the wide conical field is of moderate intensity. Such a wide conical field may be used, for example, to illuminate a large workpiece. In the second mode, the light source 50 is configured to provide a conical field of light in which the angle of the conical field is relatively narrow and the illuminated area A2 is relatively small at a predetermined distance D from the light source 50 as compared to the first mode. In the second mode, the field of illumination is focused and the intensity of the light is increased relative to the first mode. The different modes may be achieved for example by using different light sources for the different modes, or by employing the same light sources for each mode while employing different lenses 54 to achieve the desired mode. In some embodiments, switching between modes may be accomplished via a push of a button, while in other embodiments, the switch is made by rotation of a lens 54. Advantageously, the user may toggle between wide angle LEDs and focused LEDs to achieve the best illumination for a given task.

Referring to FIGS. 11 and 12, in some embodiments, the nose cap 100 may include indicator light sources 250, for example LEDs 52 that provide information to the tool user. Such indicator light sources 250 may be used alone, or in combination with illumination light sources 50, 150.

In some embodiments, the rotary power tool 1 may include a sensor 64 that detects an overload condition of the motor 6. For example, the PCBA 40 may include the sensor 64 that detects motor current, and outputs a signal corresponding to the detected current to the controller 36. The controller 36 compares the detected current to a predetermined current corresponding to a normal load condition of the rotary power tool 1. If the detected current is at or below the predetermined current, the controller 36 controls the indicator light source 250 to illuminate a green LED. The green color is used to indicate that the rotary power tool 1 is operating normally. If the detected current is greater than the predetermined current, the controller 36 controls the indicator light source 250 to illuminate a red LED. The red colored LED is used to indicate to the user that the rotary power tool 1 is operating in an overloaded state (e.g., in an abnormal state in which the tool could potentially become damaged). Placement of the indicator light sources 250 on the nose cap 100 ensures that the user can easily monitor tool status while operating the tool. FIG. 11 illustrates the indicator light sources 250 as individual LEDs 52, whereas FIG. 12 illustrates the indicator light sources 250 as axially elongate light bands provided on an outer circumferential surface of the nose cap 100. These examples are non-limiting, and the indicator light sources may be provided on the nose cap 100 in any color and configuration.

Referring to FIG. 13, an alternative embodiment indicator light source 350 is used in combination with a sensor 66 that detects an angle of the tool housing 2 in space. In some embodiments, the sensor 66 may detect an angle of the tool relative to the direction of gravity. In some embodiments, the sensor 66 may be an accelerometer that is placed in the nose cap 100 or in the tool housing 2. For example, the accelerometer 66 may be included in the PCBA 40. The accelerometer 66 outputs a signal corresponding to the detected angle of the tool to the controller 36. The controller 36 compares the detected angle to a predetermined angle. The predetermined angle may correspond to an optimal angle for using a given accessory 14 such as a cutting wheel or grinding head. If the detected angle is within an acceptable range of angles for the given application, the controller 36 controls the indicator light source 350 to illuminate a green LED. The green color is used to indicate that the rotary power tool 1 is angled appropriately. If the detected angle is greater than the acceptable range of angles, the controller 36 controls the indicator light source 350 to illuminate a red LED. The red colored LED is used to indicate to the user that the rotary power tool 1 is operating at a suboptimal angle. Placement of the indicator light sources 350 on the nose cap 100 ensures that the user can easily monitor tool status while operating the tool.

Although different color lights sources are used in this example, different types of illumination can be used to provide feedback of tool orientation. For example, the accelerometer may be used with the light sources 50, 150 described above. When the power tool is being used at an appropriate angle as detected by the accelerometer, the light sources 50, 150 may be illuminated and provide a work light, whereas when the rotary power tool 1 is being used at an inappropriate angle as detected by the accelerometer, the light sources 50, 150 turn off and remain off (or flash intermittently) until the tool housing angle is adjusted to an appropriate angle.

Referring to FIGS. 14 and 15, an alternative embodiment nose cap 400 is similar to the nose cap 100 and common elements are referred to with common reference numbers. However, the nose cap 400 of FIG. 13 differs from the nose cap 100 described above in that the nose cap 400 includes a speed control switch 80 rather than a light source 50, 150, 250, 350. That is, the speed control switch 80 is connected to the electronic circuit 20 via the electrical conductors 108.

In the nose cap 400, the speed control switch 80 is a push button switch. The speed control switch 80 is electrically connected to the controller 36 via the electrical conductors 108, and when the controller 36 determines that the speed control switch 80 is closed, the controller 36 controls the motor 6 to provide a step increase in output shaft rotational speed. For example, in some embodiments, actuation of the speed control switch 80 results in an increase in speed of 5000 rpm. In some embodiments, the increased speed is maintained as long as the switch 80 is depressed, while in other embodiments, the speed increase is temporary and lasts for a predetermined period of time.

Referring to FIG. 16, another alternative embodiment nose cap 500 is similar to the nose cap 400 of FIG. 14 and common elements are referred to with common reference numbers. However, the nose cap 500 of FIG. 16 differs from the nose cap 400 of FIG. 14 in that the push button speed control switch 80 is replaced with an integrated potentiometer speed control switch 180 (e.g., a rotary switch). The speed control switch 180 is electrically connected to the controller 36 via the electrical conductors 108, and when the controller 36 determines a change in the rotational orientation of the speed control switch 180, the controller 36 controls the motor 6 to provide a corresponding change in output shaft rotational speed.

In the embodiments disclosed with respect to FIGS. 14-16, placement of a speed control switch 80, 180 in the nose cap allows the user to control motor speed without having to change hand position from the nose grip to the tool housing grip.

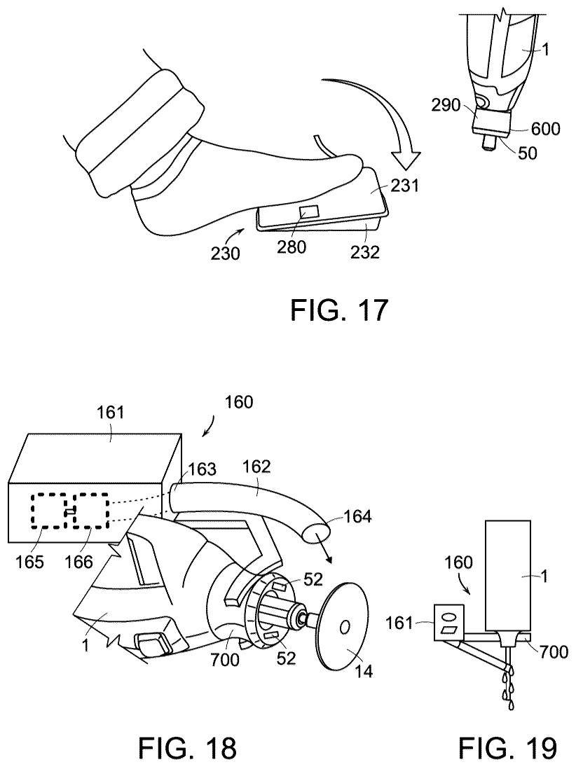

Referring to FIG. 17, another alternative embodiment nose cap 600 is similar to the nose cap 400 of FIG. 14 and common elements are referred to with common reference numbers. However, the nose cap 600 of FIG. 17 differs from the nose cap 400 of FIG. 14 in that the push button speed control switch 80 is replaced with a transceiver 290 that is wirelessly connected to the electronic circuit 20 for example using a radio frequency (RF) signal. In this embodiment, a wireless speed control switch 280 is provided in a foot pedal attachment 230. The foot pedal attachment 230 includes a pedal 231 that is pivotably mounted to a base 232. The speed control switch 280 detects the angle of the pedal 231 with respect to the base 232 and wirelessly transmits a signal to the transceiver 290 of the nose cap 600 that corresponds to the detected angle. The transceiver 290 receives the signal from the foot pedal sensor and wirelessly transmits it to the controller 36 via a receiver or transceiver provided in the PCBA 40. When the controller 36 determines a change in the angle of the speed control switch 280, the controller 36 controls the motor 6 to provide a corresponding change in output shaft rotational speed. Thus, by connecting the nose cap 600 to the rotary power tool 1, a wireless connection to the foot pedal attachment 230 is automatically established, allowing the user to control the speed of the motor via actuation of the pedal 231.

In some embodiments, the alternative embodiment nose caps 400, 500, 600 may optionally also include a light source (as illustrated in FIG. 17) in addition to the speed control features.

Referring to FIGS. 18 and 19, another alternative embodiment nose cap 700 is similar to the nose cap 400 of FIG. 14 and common elements are referred to with common reference numbers. However, the nose cap 700 of FIGS. 18 and 19 differs from the nose cap 400 of FIG. 14 in that the push button speed control switch 80 is replaced with a fluid delivery attachment 160 configured to drip fluid on a workpiece during operation of the power tool. The fluid delivery attachment 160 may include the nose cap 700 that provides a detachable connection to the rotary power tool 1. In addition, the fluid delivery attachment 160 includes a reservoir 161 mounted on the nose cap 700 that stores fluid such as water. The fluid delivery attachment includes a fluid line 162 that is connected at one end 163 to the reservoir 161. The opposed end 164 of the fluid line 162 is arranged to direct fluid from the reservoir 161 onto the workpiece or accessory 14. A fluid pump 166, an actuator 165 that drives the fluid pump 166 and other ancillary devices including appropriate valving (not shown) are disposed in the reservoir or in the fluid line 162. In addition, the PCBA 40 may include a sensor 64 that detects the current of the motor 6 of the rotary power tool 1 and outputs a signal corresponding to the detected current to the controller 36. The controller 36 compares the detected current to a predetermined current corresponding to a normal load condition of the rotary power tool 1. If the detected current is at or above the predetermined current, the controller 36 controls the actuator 165 to drive the fluid pump 166 to deliver fluid to the water line 162. If the detected current is less than the predetermined current, the controller 36 controls actuator 165 to stop the pump 166. The fluid delivery attachment 160 may deliver fluid to an accessory 14 such as a diamond glass drill bit used to drill shell, stone, glass, etcetera, to keep the drill bit cool during tool operation. Since the fluid is delivered based on a load condition of the rotary power tool 1, fluid is distributed only during tool operation.

In some embodiments, the alternative embodiment nose cap 700 may optionally also include a light source 52 (illustrated in FIG. 18) in addition to the fluid delivery attachment 160.

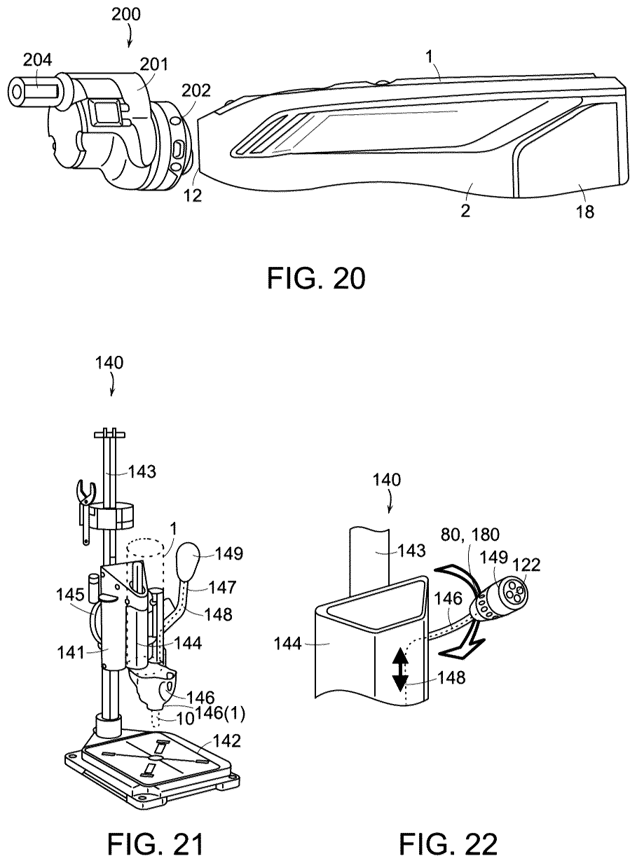

Referring to FIG. 20, another exemplary attachment 16 is a drill driver attachment 200 that converts the rotary power tool 1 to a drill driver. The drill driver attachment 200 includes a driver housing 201. A proximal end 202 of the driver housing 201 includes a threaded opening having internal threads configured to engage with the external thread 15 of the protrusion 11. The driver housing 201 houses a gear set (not shown) configured to engage with and be driven by the spindle 10. The gear set converts the output speed of the motor 6 to an appropriate drilling speed. In addition, the driver housing 201 supports a chuck 204 that is connected to an output of the gearset and is configured to transmit the output of the gearset to a drill bit (not shown).

In some embodiments, the drill driver attachment 200 may omit the gear set and include a feature such as an identification resistor that has an electrical connection with the tool housing electrical contacts 13. In this case, the controller 36 may determine that the attachment 200 is a drill driver based on the detected resistance and adjust the motor output speed to an appropriate speed for a drill bit driver.

Referring to FIGS. 21-22, another exemplary attachment 16 is a work station attachment 140 that holds the rotary power tool 1 in space and also converts the rotary power tool 1 to a press-type tool. The work station attachment 140 includes a press assembly 141 configured to rest on a support surface such as a bench top. The press assembly 141 includes a base 142 that rests on the support surface and a rail 143 that extends from the base 142 in a direction that is perpendicular to the base 142. The press assembly 141 also includes a press housing 144 that is slidably mounted on the rail 143 and supports the rotary power tool 1 in a spaced relationship relative to the base 142. The press housing 144 includes a rail mount portion 145 that is connected to the rail 143 for example via a clamp mechanism, a tool mount portion 146 that is configured to receive and support the power tool housing 2 and a gear set (not shown) that movably connects the tool mount portion 146 to the rail mount portion 145 via a lever 147 that is mechanically connected to the gearset. Operation of the lever 147 actuates the gears of the gearset whereby a position (e.g., the height) of the tool mount portion 146 is adjusted relative to the base 142. The lever 147 moves the tool mount portion 146 between a first position in which the tool mount portion 146 is a first distance from the base 142 and a second position in which the tool mount portion is a second distance from the base 142, where the second distance is closer to the base 142 than the first position.

The press assembly 142 includes embedded electrical conductors 148 that extend between the tool mount portion 146 and a handle 149 of the lever 147. One end of the electrical conductors 148 are electrically connected to electrical contacts (not shown) provided on the tool mount portion 146, which includes an internally threaded collar 146(1) that receives, and engages with, the protrusion 11. Thus, the tool mount portion 146 forms an electrical connection with the electrical contacts 13 of the tool housing 2 in a manner similar to that of the nose cap 100, whereby the tool mount portion 146 is electrically connected to the power supply 18 via the controller 36. The opposed end of the electrical conductors 148 terminate in the handle 149 of the lever 147. More specifically, the handle 149 includes a speed control switch 80, 180 that is electrically connected to the controller 36 via the electrical conductors 148. The controller 36 controls a speed of the motor based on an output signal from the speed control switch 80, 180. Since the lever handle 149 includes an integrated speed control switch 80, 180, the user has full control of the tool speed without having to release the lever 147. In some embodiments, both a speed control switch 80, 180 and a tool on/off switch 122 are provided in the handle 149 (FIG. 22).

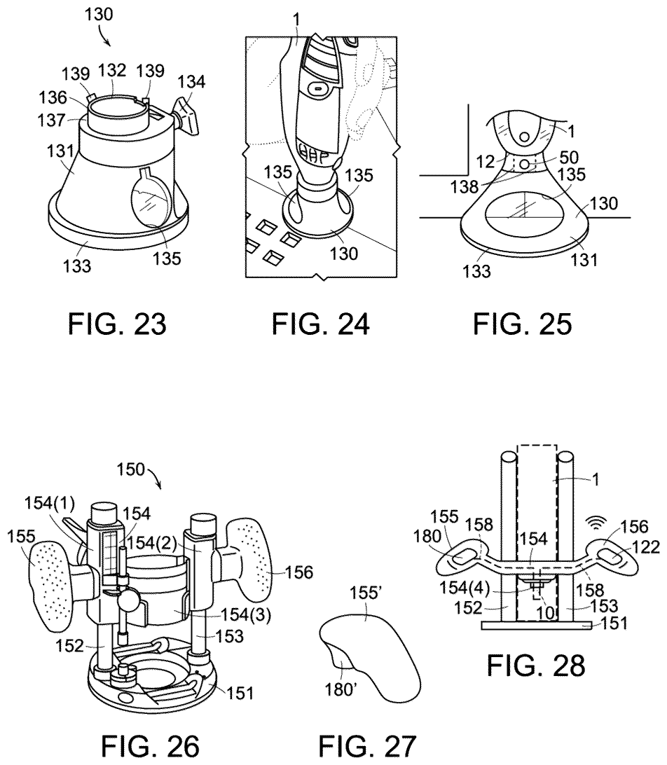

Referring to FIGS. 23-25, another exemplary attachment 16 is a cutting guide attachment 130 that attaches to the tool housing first end 12 and permits tool cutting while providing a guide to cutting depth. The cutting guide attachment 130 includes a guide housing 131 having the shape of a hollow, truncated cone. The guide housing 131 has a first end that defines a collar portion 132 and an opposed end that defines a guide surface 133. The diameter of the guide surface 133 is greater than the diameter of the collar portion 132. The collar portion 132 has an internal thread that is configured to engage with the external thread 15 of the protrusion 11 of the tool housing 2. The distance of the collar portion 132 from the guide surface 133 is adjustable via a set screw 134. The guide housing 131 further includes openings 135 that permit the user to see the interior space of the guide housing 133, particularly to provide a view of the workpiece during a cutting operation. In some embodiments, the openings 135 may be filled with a transparent material. In some embodiments, the transparent material may be configured to provide magnification.

The collar portion 132 includes a pair of embedded electrical conductors 138 that extend between a proximal end 136 and a distal end 137 of the collar portion. One end of the electrical conductors 138 are electrically connected to electrical contacts 139 provided on the collar portion proximal end 136. The collar portion 132 is removably attached to the housing first end 12 via threaded engagement between the protrusion outer thread 15 and the collar internal thread. When the collar portion 132 is attached to the tool housing first end 12, the collar portion electrical contacts form an electrical connection with the electrical contacts 13 of the tool housing first end 12, whereby the collar portion 132 is electrically connected to the power supply 18 via the controller 36. In this configuration, a portion of the spindle 10 is surrounded by collar portion 132 and an end of the spindle 10 protrudes outward from the collar portion toward the guide surface 133 to permit engagement between the spindle 10 and an accessory 14.

In the illustrated embodiment, power is supplied to a light source 50, 150, 250, 350 provided in the collar portion distal end 137 via the electrical conductors 138, which in turn are electrically connected to the power tool electrical circuit 20. When the power supply 18 is activated, the light source 50, 150, 250, 350 illuminates a work area in front of the rotary power tool 1.

Referring to FIGS. 26-28, another exemplary attachment 16 is a plunge router attachment 150 that converts the rotary power tool 1 into a compact plunge router. The plunge router attachment 150 includes a base 151 and a first and second rails 152, 153 that are fixed to and extend from the base 151 in a direction perpendicular to the base 151. The plunge router attachment 150 includes a plunge housing 154 that is a hollow, generally cylindrical structure that is supported above the base 151 by the first and second rails 152, 153. The plunge housing 154 supports the rotary power tool 1 in a spaced apart relationship with respect to the base 151. The plunge housing 154 includes a first rail mount portion 154(1) that is adjustably connected to the first rail 152, a second rail mount portion 154(2) that is adjustably connected to the second rail 153, and a tool mount portion 154(3) that is disposed between and joins the first rail mount portion 154(1) to the second rail mount portion 154(2). The tool mount portion 154(3) is suspended between the first and second rail mount portions 154(1), 154(2). The tool mount portion 154(3) includes a collar portion 154(4) that is configured to surround and support the power tool. More specifically, the collar portion 154(4) has an internal thread (not shown) that is configured to engage with the external thread 15 of the protrusion 11 of the tool housing 2. The distance of the collar portion 154(4) from the base 151 is adjustable via, for example, set screws (not shown) provided in each of the first and second rail mount portions 154(1), 154(2).

The first rail mount portion 154(1) includes a first hand grip 155 that protrudes from an outer surface of the first rail mount portion 154(1) on a side of the first rail mount portion 154(1) that is opposed to the tool mount portion 154(3). Similarly, the second rail mount portion 154(2) includes a second hand grip 156 that protrudes from an outer surface of the second rail mount portion 154(2) on a side of the second rail mount portion 154(2) that is opposed to the tool mount portion 154(3). Each of the first and second hand grips 155, 156 includes embedded electrical conductors 158 that extend between each respective hand grip and a proximal end of the collar portion 154(4). One end of the electrical conductors 158 are electrically connected to electrical contacts (not shown) provided on the collar portion proximal end. Thus, in this embodiment, the collar portion 154(4) includes four electrical contacts. The collar portion 154(4) is removably attached to the tool housing first end 12 via threaded engagement between the protrusion outer thread 15 and the collar internal thread. When the collar portion 154(4) is attached to the tool housing first end 12, the collar portion electrical contacts form an electrical connection with corresponding ones of four electrical contacts 13 provided on the tool housing first end 12, whereby the collar portion 132 is electrically connected to the power supply 18 via the controller 36. As in previous embodiments in which the attachment includes a collar portion, a portion of the spindle 10 is surrounded by the collar portion 154(4) and an end of the spindle 10 protrudes outward from the collar portion 154(4) toward the base 151 to permit engagement between the spindle 10 and an accessory 14.

In the illustrated embodiment, the first hand grip 155 includes a speed selection device 180 such as a rotary switch or slide switch that provides an output signal that corresponds to an angular position of the rotary switch (or longitudinal position of the slide switch). The controller 36 adjusts a speed of the motor 6 based the output signal from the speed selection device 180. In addition, the second hand grip 156 includes an on/off switch 122 configured to control the on/off state of the rotary power tool 1 mounted in the collar portion 154(4).

Since the plunge router attachment 150 includes an integrated switch in each of the first and second hand grips 155, 156 the user has full control of the tool speed and on/off functionality while securely holding the rotary power tool 1.

The speed selection device 180 and the on/off switch 122 are electrically connected to the electrical contacts provided on the collar portion proximal end.

FIG. 27 illustrates an alternative embodiment first hand grip 155′ in which a trigger switch 180′ provides the speed selection device 180.

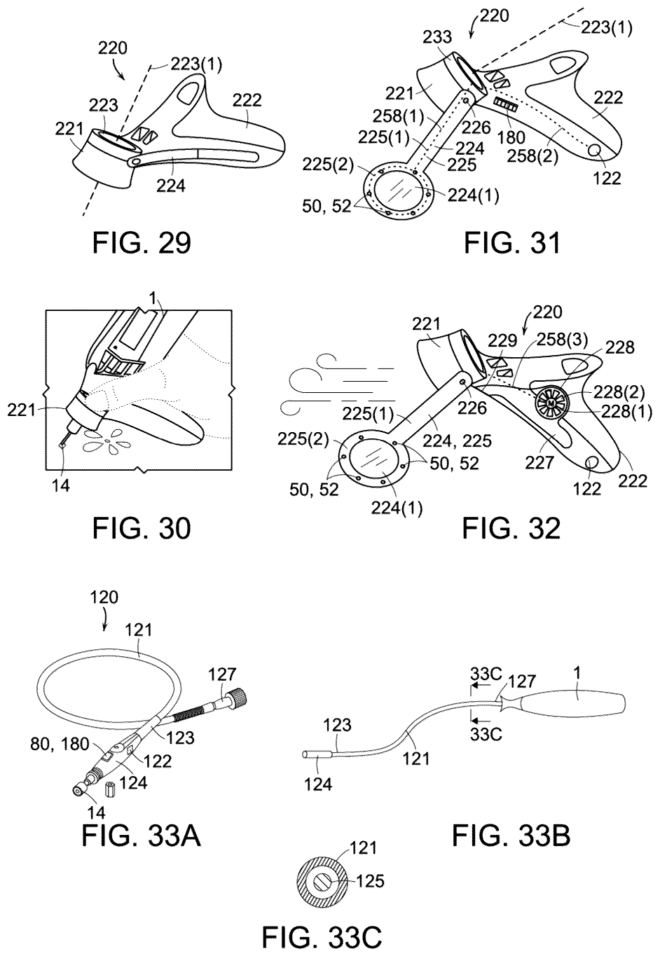

Referring to FIGS. 29-32, another exemplary attachment 16 is a detailer's grip attachment 220 that attaches to the rotary power tool first end 12 and provides a supplemental grip that is ergonomically designed to result in less fatigue particularly when using the rotary power tool 1 to perform detail work. The detailer's grip attachment 220 includes a mount portion 221 that is configured to be detachably connected to the tool housing 2 and a secondary hand grip 222 that protrudes from the mount portion 221.

The mount portion 221 includes a collar portion 223 that is configured to surround and support the power tool first end 12. More specifically, the collar portion 223 has an internal thread (not shown) that is configured to engage with the external thread 15 of the protrusion 11 of the tool housing 2. The secondary hand grip 222 extends integrally from the mount portion 221 at an acute angle relative to a centerline 223(1) of the collar portion 223. The secondary hand grip 222 has a different shape than the hand grip 4 provided by the tool housing 2. In addition, when the rotary power tool 1 is attached to the mount portion 221, the secondary hand grip 222 has a different orientation with respect to the spindle rotational axis 9 than the hand grip 4 provided by the tool housing 2.

The detailer's grip attachment 220 includes a folding magnifying device 224. The magnifying device 224 includes a frame 225 having an elongate arm portion 225(1) that is pivotably connected at one end to an outer surface of the mount portion 221 by a pin 226. The frame 225 also includes an annular rim portion 225(2) that protrudes integrally from the other end of the arm portion 225(1). The magnifying device 224 includes a magnifying lens 224(1) that is received and supported by an inner surface of the rim portion 225(2). The magnifying device 224 pivots relative to the mount portion 221 between a stored (e.g., folded and stowed) position in which the frame 225 is side-by-side with the secondary hand grip 222 (FIG. 29), and an operational position in which the arm portion 225(1) and the rim portion 225(2) are spaced apart from the secondary hand grip 222 and collar portion 223 (FIG. 31), and provides a magnified view of the workpiece to the user.

In some embodiments, the rim portion includes a light source 50, 150, 250, 350, for example LEDs 52 that are spaced apart along the rim portion 225(2) to illuminate the workpiece. The light source 50, 150, 250, 350 is powered via electrical conductors 258(1) that extend between the magnifying device rim portion 225(2) and corresponding electrical contacts disposed the proximal end of the collar portion 223.

In some embodiments, the secondary hand grip 222 includes a speed selection device 80, 180 and/or an on/off switch 122 that is electrically connected to the controller 36 via electrical conductors 258(2) that extend between the speed selection device 180 and/or on/off switch 122 and corresponding electrical contacts disposed the proximal end of the collar portion 223.

In some embodiments, the secondary hand grip 222 includes an internal vacancy 227 and an opening 229 that connects the internal vacancy 227 with an environment of the detailer's grip attachment 220. The opening 229 opens facing the workpiece. In addition, the detailer's grip attachment 220 includes a blower 228 disposed in the vacancy 227 (FIG. 32). The blower 228 includes a fan motor 228(1) that is electrically connected to the power supply 18, and a fan 228(2) that is driven to rotate by the fan motor 228(1) and is configured to expel air from the vacancy 227 via the opening 229. The fan motor 228(1) is powered via electrical conductors 258(3) that extend between the blower 228 and corresponding electrical contacts disposed the proximal end of the collar portion 223. The blower 228 integrated into the secondary grip 222 blows away the dust and debris that accumulates on the workpiece during a cutting operation, improving visibility for the user.

In some embodiments, a combination of at least two or more of the light source 50, 150, 250, 350, the speed selection device 80, 180, the on/off switch 122, and the blower 228 are provided in a the same embodiment.

The ends of the electrical conductors 258(1), 258(2), 258(3) terminate in the corresponding electrical contacts (not shown) provided on the collar portion proximal end, which in turn are configured to engage with corresponding electrical contacts 13 of the tool housing 2. When the detailer's grip attachment 220 is connected to the rotary power tool 1, the controller 36 controls a speed of the motor 6 based on an output signal from the speed selection device 80, 180.

In some embodiments, the blower 228 is not driven by a fan motor powered by the power supply 18. Instead, the fan of the blower 228 is driven by the output shaft 8 of the motor 6.

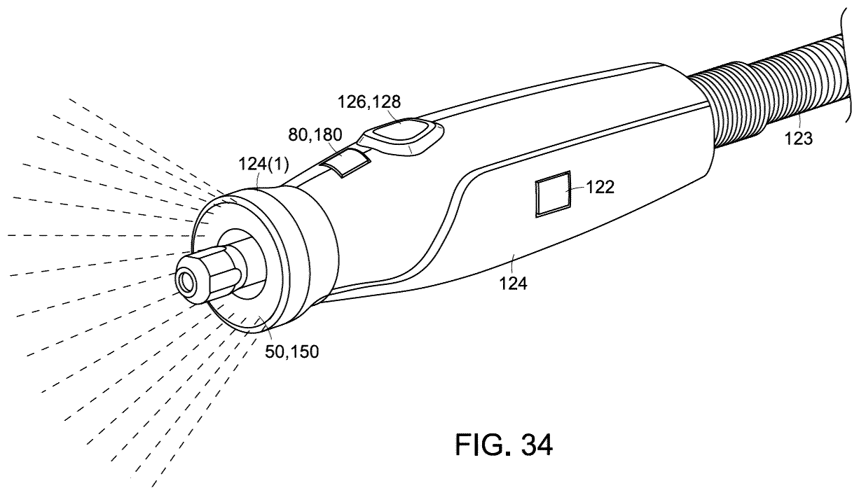

Referring to FIGS. 33A-C and 34, another exemplary attachment 16 is a flex shaft attachment 120 that attaches to the rotary power tool first end 12 and provides increased tool mobility and comfort while operating the rotary power tool 1.

The flex shaft attachment 120 includes a flexible shaft body 121 having a proximal end 127 that connects to the rotary power tool 1 and a distal end 123 opposite the proximal end 127. The flex shaft attachment 120 includes a handpiece 124 that is disposed at the flex shaft body distal end 123. The handpiece 124 is ergonomically designed to be held in the hand of a user, allowing for precise control during operation.

A rotation transmission wire 125 is disposed coaxially within the flex shaft body 121. The rotation transmission wire 125 extends from the body proximal end 127 to the body distal end 123 and is connected to the output shaft 8 of the motor 6, whereby the rotation transmission wire 125 rotates relative to the flex shaft body 121. The handpiece 124 supports the rotation transmission wire distal end which is configured to be detachably connected to the accessory 14 while the handpiece 124 is held in a hand of a user. By this configuration, the rotation transmission wire 125 is configured to transmit a rotational output of the motor output shaft 8 to the accessory 14.

In some embodiments, the handpiece 124 includes a speed selection device 80, 180, and the speed selection device is electrically connected to the controller 36 in the same manner as in previous embodiments, for example via electrical conductors (not shown) within the handpiece 124 and flex shaft body 121. The controller 36 controls a speed of the motor 6 based on an output signal from the speed selection device 80, 180. The speed selection device 80, 180 may be a button switch such as a single-press switch that provides a temporary burst of speed or an up/down toggle switch, or alternatively may be a rotary or slide switch that permits the user to increase or decrease motor speed. In some embodiments, the speed selection device 80, 180 may include multiple buttons or switches.

In some embodiments, in addition to the speed selection device 80, 180, the handpiece 124 includes an on-off switch 122 that is electrically connected to the controller 36 and is configured to control the supply of power to the motor 6.

In some embodiments, the speed selection device 80, 180 and/or the on/off switch 122 is configured to wirelessly communicate with the controller 36, and the controller 36 controls a speed of the motor 6 based on a wireless signal received from the speed selection device 80, 180.

In some embodiments handpiece 124 of the flex shaft attachment 120 includes integrated light controls that control a light source 50, 150 to enhance visibility during flex shaft operation. In the illustrated embodiment, the electrical conductors within the handpiece 124 and flex shaft body 121 supply power to the light source 50 in the form of an annular light band 150. The light band 150 may be an annular transparent structure that is illuminated. The light band 150 is mounted so as to extend around a periphery of the transmission wire distal end and to direct light forwardly toward the workpiece. In other embodiments, the light source 50, 150 may be in the form of multiple individual light sources 50 (not shown) that are contained in the handpiece nose portion 124(1) and arranged to illuminate the workpiece. In still other embodiments, the nose portion 124(1) includes two or more light sources such as light emitting diodes (LEDs) 52 (not shown) that emit light from the nose portion 124(1). Other types of light sources 50 may be used in the place of LEDs.

The light controls may include a light ON/OFF switch 126 and a light dimming control switch 128, allowing the user to adjust the brightness of the light source 50, 150 as needed. The light ON/OFF switch 126 is conveniently located on the handpiece 124, allowing the user to easily toggle the light source on and off without interrupting their work. The light ON/OFF switch 126 is electrically connected to the controller 36 in the tool housing, which manages the power supply to the light source. The dimming control switch 128 may be implemented for example as a rotary dial or slide switch. Alternatively, the dimming control switch 128 may be incorporated into the light on/off switch 126 and implemented by multiple presses of the light on/off switch 126. The dimming control switch 128 allows the user to adjust the brightness of the light source 50, 150. The dimming control switch 128 is electrically connected to the controller 36, which adjusts the power supplied to the light source 50, 150 based on the user's input.

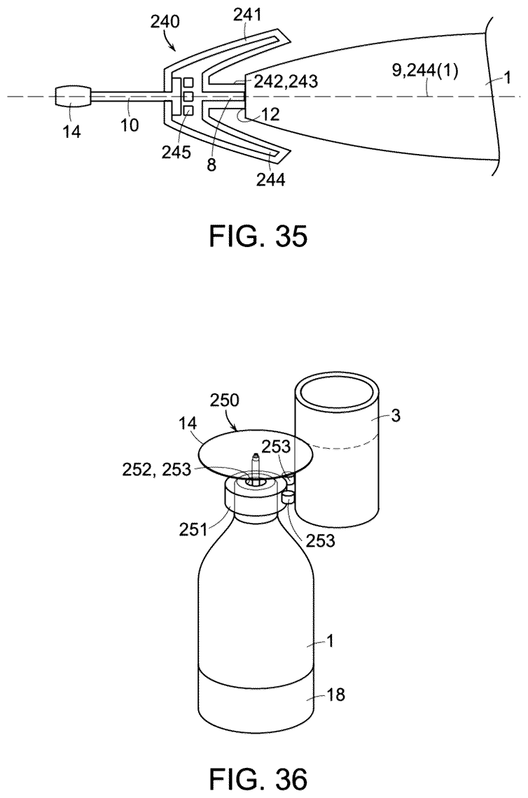

Referring to FIG. 35, another exemplary attachment 16 is a tool stabilizer attachment 240 that attaches to the rotary power tool first end 12 and provides increased tool stability and user control of the accessory 14. The tool stabilizer attachment 240 includes a generally conical stabilizer housing 241 that surrounds the spindle 11 and overlies a portion of the tool housing first end 12. The stabilizer housing 241 includes an attachment mount 242 that is supported on the stabilizer housing inner surface. The attachment mount 242 is configured to detachably connect the stabilizer housing 241 to the tool housing 2. For example, the attachment mount 242 may include a collar 243 having an internal thread (not shown) that is configured to engage with the external thread 15 of the protrusion 11 of the tool housing 2. In some embodiments, the collar 243 is omitted, and the stabilizer housing 141 connects to a nose cap 100. In addition, the tool stabilizer attachment 240 includes a gyroscope or flywheel 244 that is disposed in the stabilizer housing 241 and surrounds the tool housing first end 12. The flywheel 244 is generally conical and a rotational axis 244(1) of the flywheel 244 is coaxial with a rotational axis 9 of the spindle 11. The flywheel 244 is connected to the spindle 11 via a speed multiplier 245. The speed multiplier 245 is disposed axially outward with respect to the collar 243. An outer surface of the speed multiplier 245 is connected to the flywheel inner surface and an inner surface of the speed multiplier 245 is connected to the spindle 11, whereby the flywheel 244 rotates at a speed that is greater than the rotational speed of the motor output shaft 8. The high rotational speed of the flywheel 244 provides a counterforce that resists any force(s) coming from the cutting process creating very stable tool operating conditions.

Referring to FIG. 36, another exemplary attachment 16 is a pipe cutting attachment 250 that attaches to the rotary power tool first end 12 and supports and rotates a pipe 3 during a pipe cutting operation, simplifying the cutting process and providing a precise cut. The pipe cutting attachment 250 includes attachment housing 251 having an internal an attachment mount 252 that is configured to be detachably connected to the tool housing 2. For example, the attachment mount 252 may include a collar 253 having an internal thread (not shown) that is configured to engage with the external thread 15 of the protrusion 11 of the tool housing 2. In some embodiments, the collar 253 is omitted, and the attachment housing 251 connects to a nose cap 100. The attachment housing 251 encircles at least a portion of the tool housing first end 12. The attachment housing 251 includes rollers 253 that are pivotably mounted in the attachment housing 251 so as to protrude through housing openings. The rollers 253 are arranged so the rotational axis of each roller is parallel to a rotational axis of the spindle 11. In addition, the rollers 253 are spaced apart about the circumference of the tool housing first end 12.

In some embodiments, the rollers 253 rotate freely thus operate passively in the manner of conveyor rollers. By this configuration, the rollers 253 merely support a pipe while the rotary power tool 1 is operated to cut the pipe. In other embodiments, the rollers 253 are actively rotated via a motor (not shown) to rotate the pipe as it is being cut by the rotary power tool 1.

In embodiments in which the attachment housing 251 connects to a nose cap 100, a speed control switch 80 may be connected to the electronic circuit 20 via the electrical conductors 108. As in previous embodiments, the speed control switch 80 may be a push button switch 80 or a rotary switch 180.

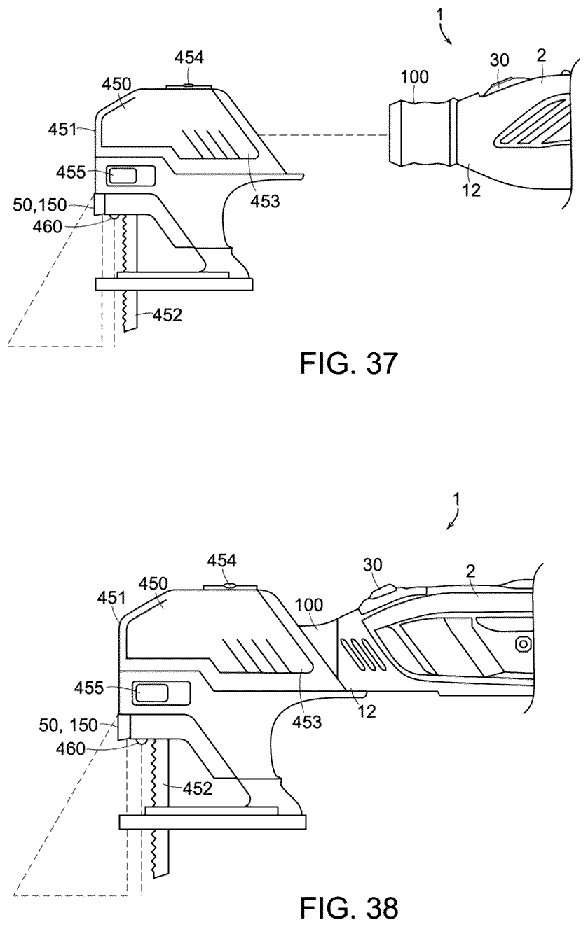

Referring to FIGS. 37 and 38, another exemplary attachment 16 is a jig saw cutting attachment 450 that detachably connects to the rotary power tool first end 12. The jigsaw cutting attachment 450 is designed to convert the rotary power tool 1 into a jigsaw, providing the ability to make intricate cuts in various materials. The jigsaw cutting attachment 450 enhances cutting precision and visibility with integrated light and laser features.

The jig saw cutting attachment 450 includes an attachment housing 451 having an attachment mount that is configured to be detachably connected to the tool housing 2. For example, the attachment mount may include a cowling 453 that encircles at least a portion of the tool housing first end 12. The cowling 453 may have an internal thread (not shown) that is configured to engage with the external thread 15 of the protrusion 11 of the tool housing 2. Alternatively, the cowling 453 may include an internal collar that receives the nose cap 100.

The attachment housing 451 houses a jigsaw blade connector (not shown) and a gear set (not shown) configured to transmit the rotary output of the tool 1 into a reciprocating output appropriate for driving a jigsaw blade 452. The jigsaw blade connector is configured to connect a jigsaw blade to an output of the gearset. In the illustrated embodiment, the jigsaw blade 452 protrudes from the cowling 453 and moves along an axis that is perpendicular to the spindle axis of rotation 9.

The jig saw cutting attachment 450 includes integrated light and laser features that improve cutting accuracy and visibility. In the illustrated embodiment, the jig saw cutting attachment 450 includes a light source 50, 150, such as LEDs, positioned at the front of the attachment housing 451 and arranged to illuminate the cutting area. The light source 50, 150 is powered by the tool's power supply 18 and is controlled by an ON/OFF switch 454 located on the jigsaw attachment housing 451. The switch 454 is electrically connected to the controller 36, allowing the user to easily toggle the light source 50, 150 on and off.

The jig saw cutting attachment 450 also includes a laser guide 460 that projects a laser beam configured as a line onto the workpiece, indicating the cutting path. The laser guide 460 is powered by the tool's power supply 18 and is controlled by a separate ON/OFF switch 455 on the jigsaw attachment housing. The switch 455 is electrically connected to the controller 36, allowing the user to activate or deactivate the laser guide 460 as needed.

In embodiments in which the attachment housing 451 connects to a nose cap 100, a speed control switch 80 may be connected to the electronic circuit 20 via the electrical conductors 108. As in previous embodiments, the speed control switch 80 may be a push button switch 80 or a rotary switch 180.

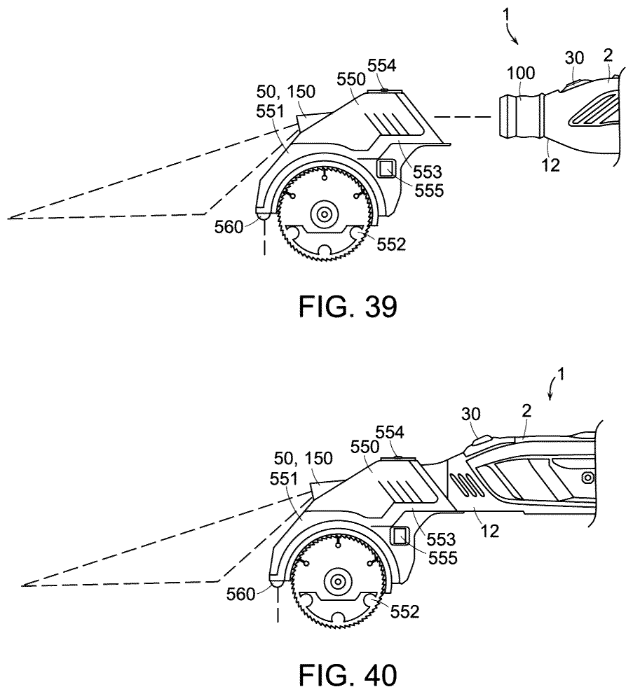

Referring to FIGS. 39 and 40, another exemplary attachment 16 is a circular saw cutting attachment 550 that detachably connects to the rotary power tool first end 12. The circular saw cutting attachment 550 is designed to convert the rotary power tool 1 into a circular saw, providing the ability to make precision cuts in various materials. The circular saw cutting attachment 550 enhances cutting precision and visibility with integrated light and laser features.

The circular saw cutting attachment 450 includes attachment housing 551 having an attachment mount that is configured to be detachably connected to the tool housing 2. For example, the attachment mount may include a cowling 553 that encircles at least a portion of the tool housing first end 12. The cowling 553 may have an internal thread (not shown) that is configured to engage with the external thread 15 of the protrusion 11 of the tool housing 2. Alternatively, the cowling 553 may include an internal collar that receives the nose cap 100.

The attachment housing 551 houses a circular saw blade connector (not shown) and a gear set (not shown) configured to transmit the rotary output of the tool 1 into a rotary output appropriate for driving a circular saw blade 552. The circular saw blade connector is configured to connect a circular saw blade 552 to an output of the gearset. In the illustrated embodiment, the circular saw blade 552 rotates about an axis that is perpendicular to and offset from the spindle axis of rotation 9.

The circular saw cutting attachment 550 includes integrated light and laser features that improve cutting accuracy and visibility. In the illustrated embodiment, the circular saw cutting attachment 550 includes a light source 50, 150, such as LEDs, positioned at the front of the attachment housing 551 and arranged to illuminate the cutting area. The light source 50, 150 is powered by the tool's power supply 18 and is controlled by an ON/OFF switch 554 located on the circular saw attachment housing 551. The switch 554 is electrically connected to the controller 36, allowing the user to easily toggle the light source 50, 150 on and off.

The circular saw cutting attachment 550 also includes a laser guide 560 that projects a laser beam configured as a line onto the workpiece, indicating the cutting path. The laser guide 560 is powered by the tool's power supply 18 and is controlled by a separate ON/OFF switch 555 on the circular saw attachment housing 551. The switch 555 is electrically connected to the controller 36, allowing the user to activate or deactivate the laser guide 560 as needed.

In embodiments in which the attachment housing 551 connects to a nose cap 100, a speed control switch 80 may be connected to the electronic circuit 20 via the electrical conductors 108. As in previous embodiments, the speed control switch 80 may be a push button switch 80 or a rotary switch 180.

Selective illustrative embodiments of rotary power tool assemblies including enhanced attachments are described above in some detail. Only structures considered necessary for clarifying the attachments have been described herein. Other conventional structures, and those of ancillary and auxiliary components of the rotary power tool and the attachments are assumed to be known and understood by those skilled in the art. Moreover, while working examples of the rotary power tool assemblies including enhanced attachments have been described above, the assemblies are not limited to the working examples described above, but various design alterations may be carried out without departing from the assemblies and attachments as set forth in the claims.

1. A hand-held rotary power tool assembly comprising:
a hand-held rotary power tool including
a power supply,
a tool housing,
a motor disposed in the tool housing, the motor including a motor output shaft that is configured to be mechanically connected to an accessory; and
a controller disposed in the tool housing, the controller configured to control a speed of the motor; and
an attachment that is configured to be connected to the tool housing, the attachment configured to be at least one of
electrically connected to the controller,
electrically connected to the power supply, and
mechanically connected to the motor output shaft.

2. The hand-held rotary power tool assembly of claim 1, comprising the accessory.

3. The hand-held rotary power tool assembly of claim 1, wherein
the attachment is a flex shaft attachment, the flex shaft attachment comprising
a shaft body having a first end that is detachably connected to the tool housing and a second end opposed to the first end, the second end comprising a handpiece configured to be held in a hand of a user; and
an internal rotation transmission wire having a proximal end that is connected to the spindle and a distal end supported on the handpiece, the rotation transmission wire transmitting a rotational output of the motor output shaft to the rotation transmission wire distal end, the rotation transmission wire distal end configured to be connected to an accessory, and wherein
the handpiece includes a speed selection device,
the speed selection device is electrically connected to the controller, and
the controller controls a speed of the motor based on an output signal from the speed selection device.

4. The hand-held rotary power tool assembly of claim 3, wherein
the output signal comprises a first output signal or a second output signal,
the speed selection device is a button switch configured so that when the button switch is not actuated, the first output signal is sent to the controller and based on the first output signal the controller maintains a current speed of the motor, and when the button switch is actuated, the second output signal is sent to the controller and the controller increases a speed of the motor by a predetermined amount.

5. The hand-held rotary power tool assembly of claim 3, wherein
the speed selection device is a rotary switch, the output signal corresponds to an angular position of the rotary switch and the controller adjusts a speed of the motor based on the output signal.

6. The hand-held rotary power tool assembly of claim 3, wherein
the handpiece comprises an on-off switch that is electrically connected to the controller and is configured to control the supply of power to the motor.

7. The hand-held rotary power tool assembly of claim 1, wherein
the attachment is a flex shaft attachment, the flex shaft attachment comprising a shaft body having a first end that is detachably connected to the motor output shaft and a second end opposed to the first end, the second end comprising a handpiece configured be detachably connected to the accessory and to be held in a hand of a user, the flex shaft attachment configured to transmit a rotational output of the motor output shaft to the accessory,
the handpiece includes a speed selection device, and
the speed selection device is configured to wirelessly communicate with the controller, and the controller controls a speed of the motor based on a wireless signal received from the speed selection device.

8. The hand-held rotary power tool assembly of claim 7, wherein
the wireless signal comprises a first wireless signal or a second wireless signal,
the speed selection device is a button switch configured so that when the button switch is not actuated, the first wireless signal is sent to the controller and based on the first wireless signal the controller maintains a current speed of the motor, and when the button switch is actuated, the second wireless signal is sent to the controller and the controller increases a speed of the motor by a predetermined amount.

9. The hand-held rotary power tool assembly of claim 7, wherein
the speed selection device is a rotary switch, the wireless signal corresponds to an angular position of the rotary switch, and the controller adjusts a speed of the motor based on the wireless signal.

10. The hand-held rotary power tool assembly of claim 7, wherein
the handpiece comprises an on-off switch that is wirelessly connected to the controller and is configured to control the supply of power to the motor.

11. The hand-held rotary power tool assembly of claim 1, wherein
the attachment is a cutting guide that is detachably connected to the tool housing, and
the cutting guide is electrically connected to the tool housing in such a way that power from the power supply is supplied to a light source that is supported on the cutting guide.

12. The hand-held rotary power tool assembly of claim 11, wherein
the light source includes LEDs arranged to direct illumination onto a workpiece.

13. The hand-held rotary power tool assembly of claim 11, wherein
the cutting guide includes a guide housing that defines a window opening configured to permit a view of the workpiece through the guide housing, and
the window opening is filled with a magnifying material.

14. The hand-held rotary power tool assembly of claim 1, wherein
the attachment is a plunge router attachment that includes a base, a first rail and a second rail that are fixed to and extend from the base, and a plunge housing that is supported above the base by the first rail and the second rail, the plunge housing supporting the power tool in a spaced apart relationship with respect to the base,
the plunge housing includes a first rail mount portion that is connected to the first rail, a second rail mount portion that is connected to the second rail and a tool mount portion that is disposed between and joins the first rail mount portion to the second rail mount portion, the tool mount portion configured to receive and support the power tool housing,
the tool mount portion including a collar portion configured to surround and support the power tool,
the first rail mount portion including a first hand grip that protrudes from an outer surface of the first rail mount portion,
the second rail mount portion including a second hand grip that protrudes from an outer surface of the second rail mount portion,
one of the first hand grip and the second hand grip includes a speed selection device, and
the speed selection device is electrically connected to the controller, and the controller controls a speed of the motor based on an output signal from the speed selection device.

15. The hand-held rotary power tool assembly of claim 14, wherein
the other of the first hand grip and the second hand grip includes an on/off switch configured to control the on/off mode of the power tool.

16. The hand-held rotary power tool assembly of claim 1, wherein
the attachment is a nose cap that is detachably connected to the tool housing so as to surround the motor output shaft, and
the nose cap is electrically connected to the tool housing in such a way that power from the power supply is supplied to a light source that is supported on the nose cap.

17. The hand-held rotary power tool assembly of claim 16, wherein
the nose cap includes a sensor that is electrically connected to controller in such a way that the sensor receives power via the controller, and
the controller receives an output signal from the sensor and is configured to control the light source based on the output signal.

18. The hand-held rotary power tool assembly of claim 1, wherein
the attachment is a nose cap that is detachably connected to the tool housing so as to surround the motor output shaft,
the nose cap includes a speed selection device, and
the speed selection device is electrically connected to the controller, and the controller controls a speed of the motor based on an output signal from the speed selection device.

19. The hand-held rotary power tool assembly of claim 1, wherein
the tool housing comprises a primary hand grip,
the attachment is a detailer's grip attachment, the detailer's grip attachment comprising an attachment mount configured to be detachably connected to the tool housing and a secondary hand grip, the secondary hand grip having a different shape or orientation than the primary hand grip,
the secondary hand grip includes a speed selection device, and
the speed selection device is electrically connected to the controller, and the controller controls a speed of the motor based on an output signal from the speed selection device.

20. The hand-held rotary power tool assembly of claim 1, wherein
the attachment is a foot pedal attachment that is wirelessly connected to the controller, the foot pedal attachment comprising a base, a pedal that is pivotably connected to the base, and a sensor configured to detect an angle of the pedal with respect to the base and wirelessly provide an output signal to the controller, the output signal corresponding to the detected angle, and the controller controls a speed of the motor based on an output signal from the foot pedal attachment.

21. The hand-held rotary power tool assembly of claim 1, wherein
the attachment is a saw attachment, the saw attachment comprising
an attachment housing configured to be detachably connected to the tool housing and encircle a portion of a circumference of the tool housing,
a cutting accessory connector and a gear set disposed in the attachment housing, the gear set configured to transmit the rotary output of the motor into a gearset rotary output appropriate for driving a cutting accessory connected to the cutting accessory connector, the gearset being connected to the cutting accessory connector and transmitting the gearset rotary output to the cutting accessory connector, and
at least one of a light control switch and a speed control switch disposed in the attachment housing, the at least one of the light control switch and the speed control switch being electrically connected to the controller,
and wherein the controller controls a speed of the motor based on an output signal from the speed control switch and controls a light source based on an output signal from the light control switch.

22. The hand-held rotary power tool assembly of claim 1, wherein
the attachment is a press assembly configured to rest on a support surface,
the press assembly includes a base that rests on the support surface, a rail that extends from the base and a press housing that supports the power tool in a spaced relationship relative to the base,
the press housing includes a rail mount portion that is connected to the rail, a tool mount portion that is configured to receive and support the power tool housing, a gear set that movably connects the tool mount portion to the rail mount portion and a lever that is mechanically connected to the gearset,
operation of the lever adjusts a position of the tool mount portion relative to the base between a first position in which the tool mount portion is a first distance from the base and a second position in which the tool mount portion is a second distance from the base,
the lever comprises a speed selection device, and
the speed selection device is electrically connected to the controller, and the controller controls a speed of the motor based on an output signal from the speed selection device.
